(19) United States
(12) Patent Application Publication
(10) Pub. No.: US 2008/0138370 A1
(43) Pub. Date: Jun. 12, 2008

(54) Solid Formulation Comprising a Phytosanitary Product

(75) Inventors: Jean-Pierre Hecaen, Stains (FR); Alessandro Chiovato, Lyon (FR); Marc Balastre, Paris (FR); Natividad Malezieux, Sevran (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Rhodia Chimie

(21) Appl. No.: 11/597,284

(22) PCT Filed: May 20, 2005
(86) PCT No.: PCT/FR2005/001267

§ 371 Date: Aug. 27, 2007

(30) Foreign Application Priority Data
May 28, 2004 (FR) 04 05801

(51) Int. Cl. A01N 25/00

(52) U.S. Cl. 424/405; 504/358

(57) ABSTRACT

The invention relates to a solid formulation containing a liquid composition containing a water-insoluble solid phytosanitary product. The invention especially relates to a solid formulation enabling the formation of nanoparticles of the phytosanitary product during a dispersion in water.

The present invention relates to a solid formulation comprising a liquid composition comprising a water-insoluble solid phytosanitary product. More particularly, the invention relates to a solid formulation allowing the formation of nanoparticles of the phytosanitary product during dispersion in water.

Agriculture uses many active materials such as fertilizers or pesticides, for example insecticides, herbicides or fungicides. These are referred to as phytosanitary products. These active materials or plant-protection products are generally produced in pure or highly concentrated form. They should be used on farms in low concentrations. To this end, the active materials are generally formulated with other ingredients in order to allow easy weight dilution by the farmer. These are referred to as phytosanitary formulations. The dilution performed by the farmer is generally prepared by mixing the phytosanitary formulation with water.

Thus, phytosanitary formulations should allow easy weight dilution by the farmer, in order to obtain a product in which the plant-protection product is correctly dispersed, for example in solution, emulsion, suspension or suspoemulsion form. The plant-protection formulations thus allow the transportation of a phytosanitary product in relatively concentrated form, easy packaging and/or easy handling for the final user. Various types of phytosanitary formulation may be used according to the various plant-protection products. Mention may be made, for example, of emulsifiable concentrates (EC), wettable powders (WP) and water-dispersible granules (WDG). The formulations that may be used depend on the physical form of the phytosanitary product (for example solid or liquid) and on its physicochemical properties in the presence of other compounds, for instance water or solvents.

After weight dilution by the farmer, for example by mixing with water, the phytosanitary product may be in various physical forms: solution, dispersion of solid particles, dispersion of droplets of the product, droplets of solvent in which the product is dissolved, etc. The phytosanitary formulations generally comprise compounds that allow these physical forms to be obtained. They may be, for example, surfactants, solvents, mineral supports on dispersants. These compounds quite often have no active nature, but an intermediary nature for aiding formulation. It is thus quite often desired to limit the amount thereof in order to limit the costs and/or any environmental unfriendliness. The phytosanitary formulations may especially be in liquid form, or in solid form, for example in the form of powder or granules.

Document WO 02/082 900 describes nanoparticles comprising a phytosanitary product and relatively small amounts of an amphiphilic compound. These nanoparticles may have advantages over particles of larger size, for example increased efficacy. The document thus describes the generation of nanoparticles by mixing a liquid composition with water.

For practical reasons, it may preferably be desired to use phytosanitary formulations in solid form. Such formulations have the advantage of being easy to handle or package and of being easy to transport.

A novel type of phytosanitary formulation has now been found, which has the advantages mentioned above in terms of transportation and packaging, and also in terms of efficacy.

Thus, the invention proposes a solid formulation comprising a liquid composition comprising a water-insoluble solid phytosanitary product dispersed in or absorbed or adsorbed onto an organic or mineral matrix, characterized in that:
the phytosanitary product is water-insoluble at 25° C.,
the liquid composition comprises:
   at least 5 parts by weight, preferably at least 25 parts and preferably at least 50 parts of the phytosanitary product,
   a solvent in which the phytosanitary product is dissolved, and
   100 parts by weight of at least one amphiphilic compound,
   the solvent, the amphiphilic compound and the proportions thereof being such that their mixture under the conditions of use, optionally in the presence of the organic matrix or of a binder and/or dispersant included in the mineral or organic matrix, is at least partially water-miscible,
   and in that the solid formulation forms, after mixing with water, a dispersion in the water of nanoparticles comprising the phytosanitary product.

The invention also relates to a process for preparing nanoparticles comprising a phytosanitary product, comprising a step of mixing the solid formulation with water. This process is advantageously performed by the farmer. As a result, for the solid formulations, this may be referred to as a “tank-mix” formulation.

The possibility of generating nanoparticles from solid formulations, in which the phytosanitary product is dispersed, absorbed or adsorbed, and thus has modified physicochemical properties, for example interface properties, is a surprising effect.

### Definitions

In the present patent application, a water-insoluble product denotes a product which, at 1% by weight in distilled water, at 25° C., presents macroscopic phase separation.

In the present patent application, a water-miscible liquid or mixture denotes a liquid or mixture that does not show any macroscopic phase separation from 0% (exclusive) to 99% by weight relative to the total weight of the mixture of water and of the liquid or mixture, at 25° C.

In the present patent application, a liquid or mixture that is partially miscible with water denotes a liquid or mixture that does not show any macroscopic phase separation from 0% (exclusive) to 25% by weight relative to the total weight of the mixture of water and of the liquid or mixture, at 25° C.

In the present patent application, nanoparticles denote solid particles of less than 1060 nm. The nanoparticles are generally in a form dispersed in a liquid. The particle size is defined as being the median weight or volume diameter, which may be measured using a Malvern Mastersizer S machine (for example version 2.18), with a polydisperse theoretical model and a presentation of the Standard-Wet type (3OHD) assuming a suspension in water. The median weight or volume diameter is that for which 50% by weight or volume of the sample measured has a smaller diameter and 50% by weight of the sample measured has a larger diameter. It is not excluded for the nanoparticles to comprise particles larger than 1060 nm. Preferably, at least 75% by weight or volume of the nanoparticles are smaller than 1060 nm and even more preferably smaller than 400 nm. The particle size is measured in the absence of a matrix mineral or organic support. If such a support is present in the dispersion, it is removed, for example by decantation and/or filtration before measuring.

### General Embodiments of the Solid Formulations

According to a first embodiment, the solid formulation is a dried emulsion (DE), comprising an organic matrix in which are dispersed inclusions of the liquid composition. The matrix of the dried emulsions generally comprises a water-soluble or water-dispersible polymer. Dried emulsions and processes for preparing them are especially described in documents WO 97/15385 (R 95139G1), WO 00/26280 (R 98145), WO 02/32563 (R 00137), WO 03/006148 (R 01103), WO 99/55819, U.S. Pat. No. 3,971,852, WO 97/15386 (R 95140), WO 97/15387 (R 95141), WO 99/38611 (R 98011) and WO 99/38945 (R 98010).

According to a second embodiment, the solid formulation is a wettable powder (WP) comprising a matrix mineral or organic support onto which the liquid composition is absorbed or adsorbed, and comprising an agent for promoting the dispersion of the mineral support in water.

According to a third embodiment, the solid formulation is a water-dispersible solid granule (WDG), comprising an agglomerate of a matrix mineral or organic support onto which the liquid composition is absorbed or adsorbed, and optionally comprising a binder and/or dispersant for promoting the dispersion in the water of the support. The matrix mineral support is generally a powder agglomerated to form the granule. The powder may typically have a particle size of from 0.5 to 50 μm. A granule may typically have a particle size of at least 0.1 mm in diameter, for example from 0.1 to 3 mm in diameter. When the granule is prepared by extrusion, the granule may typically have a cylindrical shape, of circular cross section or the like, with a length of from 1 to 6 mm and a diameter or width of from 0.2 to 2 mm. After dispersion in water, with moderate stirring, the granule is deagglomerated, and the matrix mineral or organic support forms small particles in suspension, which can pass through spraying devices. According to one advantageous mode, the granule is such that after stirring for 5 minutes in water, there is less than 0.01% by weight of a residue of deagglomerated particles on a 150 μm screen, and advantageously less than 0.5% by weight on a 53 μm screen.

### Ingredients

The various types of ingredient that may be included in the solid formulations according to the invention are detailed below.

### Phytosanitary Product

As nonlimiting examples of suitable active materials, mention may be made, inter alia, of Ametryne, Diuron, Linuron, Chlortoluron, Isoproturon, Nicosulfuron, Metamitron, Diazinon, Aclonifen, Atrazine, Chlorothalonil, Bromoxynil, Bromoxynil heptanoate, Bromoxynil octanoate, Mancozeb, Manebe, Zineb, Phenmedipham, Propanyl, the series of phenoxyphenoxy products, the series of heteroaryloxyphenoxy products, CMPP, MCPA, 2,4-D, Simazine, the active products of the imidazolinone series, the family of organophosphorus products, especially including Azinphos-ethyl, Azinphos-methyl, Alachlore, Chlorpyriphos, Diclofop-methyl, Fenoxaprop-p-ethyl, Methoxychlore, Cypermethrine, Fenoxycarbe, cymoxanil, chlorothalonyl, neonicotinoid insecticides, the family of triazole fungicides such as azaconazole, bromuconazole, cyproconazole, difenoconazole, diniconazole, epoxyconazole, fenbuconazole, flusilazole, myclobutanyl, tebuconazole, triadimefon, triadimenol, strobilurines such as pyraclostrobin, picoxystrobin, azoxystrobin, famoxadone, kresoxym-methyl and trifloxystrobin, and sulfonylureas such as bensulfuron-methyl, chlorimuron-ethyl, chlorsulfuron, metsulfuron-methyl, nicosulfuron, sulfomethuron-methyl, triasulfuron and tribenuron-methyl.

The water-insoluble products are chosen from this list.

### Solvent

The liquid composition comprises a solvent in which the phytosanitary product is dissolved. This is a solvent other than water. The nature of the solvent depends on the phytosanitary product. As solvents that are often used in phytosanitary formulations, mention is made of hydrocarbon fractions such as Solvesso, C₁-C₄ esters of fatty acids, and alcohols such as methanol.

Solvents that may be used especially include:
esters of linear or branched, saturated or unsaturated monocarboxylic or dicarboxylic acids containing 2 to 15 carbon atoms, optionally comprising an alkoxy group, preferably methoxy, or hydroxyl, and of a linear or branched, saturated or unsaturated monoalcohol or polyol containing 1 to 13 carbon atoms;
phosphate monoesters, diesters and/or triesters, comprising C₂-C₅ alkyl groups, and alkyl phosphonates, with a C₂-C₅ alkyl group, for example tributyl phosphate (TBP);
ketones for which the identical or different radicals are linear or branched alkyl radicals containing 1 to 5 carbon atoms;
heterocyclic derivatives comprising at least one nitrogen and/or at least one oxygen and/or at least one sulfur atom;
polyalcohol monoethers or polyethers;
DMSO (dimethyl sulfoxide);
lactic acid esters;
glyceryl carbonate;
THFA (tetrahydrofurfuryl alcohol);
carboxylic acid dimethylamides, for example sold by the company Clariant under the name Genagene; especially described in document U.S. Pat. No. 5,206,225;
lactate esters, for example sold by the company Purac, especially described in document WO 03/075 657;
alone or as a mixture.

This list is not exhaustive.

As regards the carboxylic acid esters, they may be chosen more particularly from acetic, caprylic, octanoic, decanoic, dodecanoic, lauric and lauroleic acid esters, alone or as mixtures. When the acid is a dicarboxylic acid, the two carboxylic functions are preferably in esterified form. Moreover, the alcohol from which the ester is formed is preferably a monoalcohol.

It would not constitute a departure from the context of the present invention to use products derived from the alcoholysis (more particularly methanolysis or ethanolysis) of triglycerides of animal or, preferably, plant origin. Examples of suitable triglycerides that may be mentioned include groundnut oil, cottonseed oil, linseed oil, olive oil, palm oil, grapeseed oil, soybean oil, castor oil, rapeseed oil, copra oil or coconut oil.

Among the suitable ketones that may be mentioned are acetone, methyl ethyl ketone and methyl isobutyl ketone, alone or as a mixture.

As regards the heterocyclic derivatives comprising at least one nitrogen and/or oxygen and/or sulfur atom, mention may be made especially of N-methylpyrrolidone, tetrahydrofuran, dioxane, etc.; N-methylpyrrolidone being preferred.

As regards the polyalcohol monoethers or polyethers, they are preferably such that the ether part(s) comprise(s) one or more alkyl radicals containing from 1 to 4 carbon atoms. As regards the part derived from the polyalcohol, the latter is preferably of the polyethylene glycol type. Methyldiglycol may be used, for example.

### Water-Soluble or Water-Dispersible Polymer of Organic Matrix

Any water-soluble or water-dispersible polymer suitable for preparing dried emulsions may be used. The polymer may be chosen, for example, from polyvinyl alcohol (PVA), optionally modified starches, and copolymers of (meth)acrylic acid or of maleic anhydride and of diisobutylene. Polymers that are suitable for implementing this embodiment are especially described in documents WO 97/15385 (R 95139G1), WO 00/26280 (R 98145), WO 02/32563 (R 00137), WO 03/006148 (R 01103), WO 99/55819, U.S. Pat. No. 3,971,852, WO 97/15386 (R 95140), WO 97/15387 (R 95141), WO 99/38611 (R 98011) and WO 99/38945 (R 98010). An example that is mentioned is Geropon EGPM, sold by Rhodia.

### Matrix Mineral Support

The matrix mineral support is generally a water-insoluble mineral filler that has the capacity of absorbing or adsorbing a liquid. The mineral filler may be more or less porous, and may have a more or less large specific surface area. It is noted that the mineral filler may be in the form of a powder. The grains of the powder may themselves consist of agglomerates and/or aggregates of objects of smaller size (particles or particle aggregates).

The matrix mineral support may thus be chosen from:
silica, preferably a precipitation silica,
mineral compounds comprising phosphorus,
silicates or metasilicates of alkali metal or alkaline-earth metal compounds,
carbonates of alkali metal or alkaline-earth metal compounds,
carbon black,
clays, or
mixtures of these compounds.

The mineral fillers used may have a specific surface area, measured according to the BET methods (determined according to the Brunauer-Emmett-Teller method described in the Journal of the American Chemical Society, Vol. 60, page 309, February 1938, and corresponding to NFT standard 45007 (November 1997)), of at least 50 m²/g, especially between 50 and 400 m²/g and preferably greater than 70 m²/g. They may also have an apparent density of less than 200 g/l. They may have a DOP oil uptake of at least 200 ml/g (determined according to ISO standard 787/5 using dioctyl phthalate). It may be, for example, a precipitation silica with a DOP oil uptake of at least 200 ml/g.

The mineral filler may be chosen from silica, ground quartz, calcined clays, or diatomaceous earths, oxides, hydroxides or sulfates of elements from columns IIA or IIIB of the Periodic Table of the elements, mica and gypsum, alone or as mixtures.

The silica is preferably a precipitation silica. Preferably, it is not a calcined silica. It may optionally have undergone a surface treatment directed toward making it hydrophobic. It should be noted that this treatment may be performed beforehand or in situ. Conventionally, the hydrophobation treatment consists in placing the silica in contact with one or more organosilicon compounds. Among these compounds, mention may be made of methylpolysiloxanes such as hexamethyldisiloxane, octamethylcyclotetrasiloxane; methylpolysilazanes such as hexamethyldisilazane, hexamethylcyclotrisilazane; chlorosilanes such as dimethyldichlorosilane, trimethylchlorosilane, methylvinyldichlorosilane, dimethylvinylchlorosilane; alkoxysilanes, for instance dimethylmethoxysilane, and MQ resins. During this treatment, the silicas may increase their starting weight by up to 20%.

As an example of a matrix mineral support (mineral filler) that may be used, mention is made of the silica Tixosil® 38 AB sold by Rhodia.

The matrix mineral support may also be a mineral filler chosen from calcium or magnesium silicates or metasilicates, titanium dioxide, aluminum, zinc or calcium oxide, calcium, zinc or magnesium carbonate, sodium, ammonium or calcium sulfate, bentonite, kaolin, attapulgite, zeolites, fused sodium potassium, aluminum silicates (heat-treated perlite) or carbon black.

The size of the mineral filler is preferably less than 150 μm, after dispersion of the solid formulation in water. It is preferably between 2 and 50 μm. Large-sized fillers may pose problems of implementation in agricultural devices.

### Amphiphilic Compound

Without wishing to be bound by any theory, it is thought that the amphiphilic compound aids in the stabilization and/or formation of the nanoparticles. It may also aid, to a certain extent, in compatibilizing the solid composition with the organic or mineral matrix, or in facilitating the contact of the liquid composition with the other compounds. In the context of dried emulsions, the amphiphilic compound may aid in forming the emulsion.

The amphiphilic compound comprises two separate and unmixed parts: a hydrophobic part and a hydrophilic part. In this respect, the amphiphilic compound is not a statistical copolymer comprising randomly distributed (mixed) hydrophobic units and hydrophilic units.

According to a first embodiment, the amphiphilic compound is a surfactant. Surfactants are known compounds, which generally have a relatively low molar mass, for example less than 1000 g/mol. The surfactant may be an anionic surfactant in salified or acidic, nonionic, preferably polyalkoxylated, cationic or amphoteric (term also including zwitterionic surfactants) form, or a mixture of these surfactants.

Examples of anionic surfactants that may be mentioned, without wishing to be limited thereto, include:
alkylsulfonic acids or arylsulfonic acids, optionally substituted with one or more hydrocarbon-based groups, and the acid function of which is partially or totally salified, for instance C₈-C₅₀, more particularly C₈-C₃₀ and preferably C₁₀-C₂₂ alkylsulfonic acids, benzenesulfonic acids or naphthalenesulfonic acids substituted with one to three C₁-C₃₀, preferably C₄-C₁₆ alkyl and/or C₂-C₃₀, preferably C₄-C₁₆ alkenyl groups,
alkylsulfosuccinic acid monoesters or diesters, the linear or branched alkyl part of which is optionally substituted with one or more hydroxylated and/or linear or branched C₂-C₄ alkoxylated (preferably ethoxylated, propoxylated or ethopropoxylated) groups,
phosphate esters chosen more particularly from those comprising at least one linear or branched, saturated, unsaturated or aromatic hydrocarbon-based group containing 8 to 40 and preferably 10 to 30 carbon atoms, optionally substituted with at least one alkoxylated (ethoxylated, propoxylated or ethopropoxylated) group. In addition, they comprise at least one monoesterified or diesterified phosphate ester group such that one or two free or partially or totally salified acid groups may be present. The preferred phosphate esters are of the type such as monoesters and diesters of phosphoric acid and of alkoxylated (ethoxylated and/or propoxylated) mono-, di- or tristyrylphenol, or of alkoxylated (ethoxylated and/or propoxylated) mono-, di- or trialkylphenol, optionally substituted with one to four alkyl groups; of phosphoric acid and of an alkoxylated (ethoxylated or ethopropoxylated) C₈-C₃₀ and preferably C₁₀-C₂₂ alcohol; of phosphoric acid and of a nonalkoxylated C₈-C₂₂ and preferably C₁₀-C₂₂ alcohol,
sulfate esters obtained from saturated or aromatic alcohols, optionally substituted with one or more alkoxylated (ethoxylated, propoxylated or ethopropoxylated) groups, and for which the sulfate functions are in free or partially or totally neutralized acid form. Examples that may be mentioned include the sulfate esters obtained more particularly from saturated or unsaturated C₈-C₂₀ alcohols, which may comprise 1 to 8 alkoxylated (ethoxylated, propoxylated or ethopropoxylated) units; the sulfate esters obtained from polyalkoxylated phenol, substituted with 1 to 3 saturated or unsaturated C₂-C₃₀ hydrocarbon-based groups, and in which the number of alkoxylated units is between 2 and 40; the sulfate esters obtained from polyalkoxylated mono-, di- or tristyrylphenol in which the number of alkoxy units ranges from 2 to 40.

The anionic surfactants may be in acid form (they are potentially anionic) or in a partially or totally salified form, with a counterion. The counterion may be an alkali metal, such as sodium or potassium, an alkaline-earth metal, such as calcium, or an ammonium ion of formula N(R)₄⁺ in which R, which may be identical or different, represents a hydrogen atom or a C₁-C₄ alkyl radical optionally substituted with an oxygen atom.

Examples of nonionic surfactants that may be mentioned, without wishing to be limited thereto, include:
polyalkoxylated (ethoxylated, propoxylated or ethopropoxylated) phenols substituted with at least one C₄-C₂₀ and preferably C₄-C₁₂ alkyl radical, or substituted with at least one alkylaryl radical, the alkyl part of which is C₁-C₆. More particularly, the total number of alkoxy units is between 2 and 100. Examples that may be mentioned include polyalkoxylated mono-, di- or tri(phenylethyl) phenols, or polyalkoxylated nonylphenols. Among the ethoxylated and/or propoxylated, sulfated and/or phosphated di- or tristyrylphenols, mention may be made of ethoxylated bis(1-phenylethyl)phenol, containing 10 oxyethylene units, ethoxylated bis(1-phenylethyl)phenol, containing 7 oxyethylene units, ethoxylated sulfated bis(1-phenylethyl)phenol, containing 7 oxyethylene units, ethoxylated tris(1-phenylethyl)phenol, containing 8 oxyethylene units, ethoxylated tris(1-phenylethyl)phenol containing 16 oxyethylene units, ethoxylated sulfated tris(1-phenylethyl)phenol, containing 16 oxyethylene units, ethoxylated tris(1-phenylethyl)phenol, containing 20 oxyethylene units, and ethoxylated phosphated tris(1-phenylethyl)phenol, containing 16 oxyethylene units,
optionally polyalkoxylated (ethoxylated, propoxylated or ethopropoxylated) C₆-C₂₂ fatty alcohols or fatty acids. When they are present, the number of alkoxy units is between 1 and 60. The term “ethoxylated fatty acid” includes both the products obtained by ethoxylation of a fatty acid with ethylene oxide and those obtained by esterification of a fatty acid with a polyethylene glycol,
polyalkoxylated (ethoxylated, propoxylated or ethopropoxylated) triglycerides of plant or animal origin. Triglycerides derived from lard, tallow, groundnut oil, butter oil, cottonseed oil, linseed oil, olive oil, palm oil, grapeseed oil, fish oil, soybean oil, castor oil, rapeseed oil, copra oil or coconut oil, and comprising a total number of alkoxy units of between 1 and 60, are thus suitable for use. The term “ethoxylated triglyceride” is directed both toward the products obtained by ethoxylation of a triglyceride with ethylene oxide and toward those obtained by transesterification of a triglyceride with a polyethylene glycol,
polyalkoxylated (ethoxylated, propoxylated or ethopropoxylated) sorbitan esters, more particularly cyclized sorbitol esters of C₁₀ to C₂₀ fatty acids, for instance lauric acid, stearic acid or oleic acid, and comprising a total number of alkoxy units of between 2 and 50.

The polyalkoxylated, preferably polyethoxylated and/or polypropoxylated, surfactants may be particularly preferred in the context of dried emulsions.

According to a second embodiment, the amphiphilic compound is a block copolymer, comprising a hydrophilic block, comprising hydrophilic units, derived from hydrophilic monomers, and a hydrophobic block, comprising hydrophobic units, derived from hydrophobic monomers. The block copolymer is advantageously a diblock copolymer. Preferably, at least one block, preferably two or at least two blocks, are derived from mono-α-ethylenically unsaturated monomers. Examples of block copolymers that are suitable for this embodiment are described in document WO 02/082 900.

It should be noted that it is possible to use several amphiphilic compounds. Generally, the amphiphilic compound may be a mixture of amphiphilic compounds, for example of compounds as detailed below. Mixtures of block copolymers and of surfactants may be used, for example.

Binder and/or Dispersant

The mineral or organic matrix may comprise a binder and/or dispersant. The presence of such a binder and/or dispersant is particularly advantageous in a solid formulation in the form of a water-dispersible granule (WDG). In the context of water-dispersible granules, the binder and/or dispersant may allow agglomeration of the matrix mineral or organic support, and/or deagglomeration of the matrix mineral or organic support (dispersion of support particles) during dispersion in water. The binder and/or dispersant may be a mixture of several binders and/or dispersants. In the context of wettable powders, the dispersant and/or binder may promote the dispersion of the mineral support in water.

The binder and/or dispersant may especially be a water-soluble or water-dispersible polymer as described above as water-soluble or water-dispersible polymer of the organic matrix. The polymer may be chosen, for example, from polyvinyl alcohol (PVA), modified starches, and copolymers of (meth)acrylic acid or of maleic anhydride and of diisobutylene. An example that is mentioned is Geropon EGPM, sold by Rhodia.

The binder and/or dispersant may be chosen especially from the following compounds:
water-soluble polymers, preferably polycarboxylates, and derivatives and/or copolymers thereof,
naphthalenesulfonate condensates,
condensed naphthalenesulfonate/formaldehyde polymers (sodium or ammonium salts),
phenylsulfonate condensates (sodium salts of phenylsulfonic acids),
crosslinked polyvinylpyrrolidones,
polysaccharides and derivatives thereof,
copolymers, preferably block copolymers, of ethylene oxide and of propylene oxide,
sulfoesters,
lignosulfonates,
mixtures of these compounds.

The lignosulfonates may be in acid form or in the form of a salt, in combination with a counterion. Mention may be made of Na, K, Ca, Mg or NH₄ lignosulfonates and most particularly the Na lignosulfonate, and, for economic reasons, the Ca lignosulfonate. An example of a calcium lignosulfonate that may be mentioned is the Bretax range sold by Burgo. An example of the sodium lignosulfonate that may be mentioned is Reax 88B sold by Westvaco.

The binders and/or dispersants may be chosen from polysaccharides and derivatives thereof, for instance starch, microcrystalline cellulose, crosslinked sodium carboxymethylcellulose or soybean polysaccharides.

They may also be chosen from copolymers of ethylene oxide and of propylene oxide, preferably block copolymers, especially compounds with a molecular mass of between 3000 and 25 000 g/mol.

The binders and/or dispersants may also be chosen from the following compounds:
the alkali metal or ammonium salts of alkylnaphthalenesulfonates condensed with formaldehyde;
the alkali metal or ammonium salts of 4,4′-dihydroxybiphenylsulfonate condensed with formaldehyde;
the alkali metal or ammonium salts of polymers comprising at least one monomer chosen from C₃-C₅ unsaturated acids, diacids or anhydrides, optionally combined with at least one monomer chosen from linear or branched, unsaturated C₄-C₈ hydrocarbon-based radicals. Polymers comprising, as monomers, maleic acid, maleic anhydride, acrylic acid or methacrylic acid, alone or as mixtures, may be used more particularly. Said polymers may similarly comprise at least one monomer chosen from isobutylene and diisobutylene. These polymers may be in an acidic form or in the form of an alkali metal or ammonium salt of the type N(R³)₄⁺ with R³, which may be identical or different, representing hydrogen atoms or C₁-C₄ hydrocarbon-based radicals. Preferably, the copolymer is in the form of sodium salts. Preferably, a polymer comprising maleic acid and/or maleic anhydride combined with isobutylene and/or diisobutylene is used.

Similarly, a combination of an alkylbenzenesulfonate salt (more particularly such as alkylbenzenesulfonates and preferably sodium dodecylbenzenesulfonate) with the abovementioned polymer, i.e. the polymer comprising maleic acid, and/or maleic anhydride combined with isobutylene and/or diisobutylene, preferably in the form of a sodium salt, may advantageously be used. The weight ratio of the salt to the polymer is more particularly 10/90.

As nonlimiting illustrations, the dispersants may be chosen from the following products: Geropon® T36, Geropon® TA/72, Geropon® SC/213, Supragil® MNS/90, Supragil® GN, Soprophor® FL, Soprophor® FLK, sold by Rhodia.

The amount of dispersant in the solid phytosanitary composition is generally between 2% and 20% by weight relative to the total weight of the composition, and preferably between 2% and 15% by weight relative to the same reference. It is advantageously between 2% and 10% by weight relative to the total weight of the solid phytosanitary composition.

Salts, preferably water-soluble salts, may also be used, for example to promote the dispersion of an agglomerated mineral matrix. They may serve as disintegrants. As salts that are useful in this respect, mention is made of:
sodium citrate,
sodium bicarbonate,
sodium acetate,
sodium metasilicate,
magnesium, zinc or calcium sulfates,
magnesium hydroxide,
calcium or sodium chloride,
sodium or ammonium sulfate.

### Other Ingredients

The solid formulation according to the invention may also comprise wetting agents, anticaking agents, chemical stabilizers, inert fillers, antifoams, agents for stabilizing the size of the nanoparticles or agents for inhibiting the growth of the nanoparticles.

Among the suitable wetting agents that may be mentioned, without wishing to be limited thereto, are N-methyl-N-oleoyl taurates; alkylarylsulfonate salts, for instance alkylbenzenesulfonate salts, alkyldiphenyl ether sulfonate salts, alkylnaphthalenesulfonate salts; monoalkyl sulfosuccinates, dialkyl sulfosuccinates; ethoxylated alkylphenols. These wetting agents may be used alone or as a mixture. Examples of wetting surfactants that may be mentioned include Geropon® SDS, Geropon® T/77, Supragil® NC/85, Rhodacal® DS/10 and Supragil® WP, solid by Rhodia. The amount of wetting agent may be between 0.5% and 10% by weight relative to the total weight of the solid formulation, and preferably between 1% and 5% by weight relative to the same reference.

Without wishing to be bound to any theory, it is thought that the wetting agents may aid in making the mineral or organic support compatible with water that may be used during the preparation of the solid formulation, in particular during the preparation of wettable powders and of water-dispersible granules. They may also aid in dispersing the solid formulation in water.

Among the chemical stabilizers that may be mentioned, without wishing to be limited thereto, are alkaline-earth metal or transition metal sulfates, sodium hexametaphosphate, calcium chloride, boric anhydride, etc.

Among the agents for stabilizing the size of the nanoparticles or agents for inhibiting the growth of the nanoparticles, mention may be made of polyvinylpyrrolidone (PVP).

It is pointed out that it is possible for an ingredient to exert several functions in the solid formulation. For example, surfactants may have a dispersing effect or function, ingredients may have both a dispersing and binding effect or function, etc.

### Amounts—Physicochemistry

The solvent, the amphiphilic compound and the proportions thereof are such that their mixture under the conditions of use, optionally in the presence of the organic matrix or of a binder and/or dispersant included in the mineral or organic matrix, is at least partially water-miscible.

According to a first test, the water-miscibility is tested by preparing a mixture comprising the solvent and the amphiphilic compound, without the phytosanitary product, and the ingredients of the organic or mineral matrix, and then by placing this mixture in contact with water, in accordance with the test defined above.

According to a second test, the water-miscibility may be tested by preparing a mixture comprising the solvent and the amphiphilic compound, the organic matrix (in the context of a solid formulation in the form of a dried emulsion), or the dispersant and/or binder (in the context of a solid formulation in the form of a wettable powder or a water-dispersible granule), without the phytosanitary product and without the ingredients of the matrix mineral support, followed by placing this mixture in contact with water, in accordance with the test defined above.

The solvent/amphiphilic compound system or the solvent/amphiphilic compound/organic matrix system or the solvent/amphiphilic compound/dispersant and/or binder system is chosen such that at least one of the above two tests is satisfied.

The ingredients and the proportions thereof are moreover such that the solid formulation forms, after mixing with water, a dispersion in water of nanoparticles comprising the phytosanitary product. The formation of nanoparticles may be tested by mixing the solid formulation with water, and by performing a measurement in accordance with the above definitions. The formation of nanoparticles may be tested by introducing 0.3 part by weight of the liquid composition per 100 parts of water and/or by introducing 1 part by weight of granules into 100 parts of water.

According to preferential embodiments:
the weight ratio between the solvent and the phytosanitary product is between 5/95 and 95/5,
the weight ratio between the liquid composition and the matrix mineral support (in the case of water-dispersible granules WDG or wettable powders WP) is between 0.5/1 and 3/1,
the weight ratio between the organic matrix (in the case of dried emulsions EG) and the solid formulation is less than 50%.

Moreover, the solid formulation advantageously comprises at least 1% by weight, usually at least 0.5% by weight, for example between 10% and 50% by weight, of solvent.

### Process for Forming Granules

Several processes exist that are suitable for preparing the solid formulations according to the invention. The processes for preparing solid formulations are known to those skilled in the art. Naturally, the processes that may be used may vary, as may the ingredients, depending on the desired type of solid formulation, for example a dried emulsion (EG), a wettable powder (WP) or a water-dispersible solid granule (WDG).

According to one embodiment of the invention, the solid formulation is a dried emulsion. A process suitable for preparing such a formulation comprises the following steps:
forming an emulsion in water of the liquid composition, said emulsion comprising the amphiphilic compound, and, in the aqueous phase, the water-soluble or water-dispersible polymer that will form the matrix,
removing the water,
recovering the solid formulation.

During a first step of the process, an emulsion comprising the liquid composition, dispersed in the aqueous phase, is prepared. The emulsion comprises the water-soluble or water-dispersible polymer.

Any method for preparing an emulsion may be used. These methods are known to those skilled in the art. Methods are described, for example, in the “Encyclopedia of Emulsion Technology”, volumes 1 to 3 by Paul Becher, published by Marcel Dekker Inc., 1983, and may be used in the context of the present invention.

Thus, the “direct-phase emulsification” method may be used. It is briefly recalled that this method consists in preparing a mixture containing the water and emulsifiers (amphiphilic compounds), including the water-soluble or water-dispersible polymer, and then in introducing the liquid composition, with stirring.

Another suitable method is phase-inversion emulsification. According to this route, the liquid composition is mixed with an emulsifier, and the water, possibly containing the other constituents, for instance the water-soluble or water-dispersible polymer, is introduced dropwise with stirring. At and above a certain amount of introduced water, inversion of the emulsion takes place. An oil-in-water direct emulsion is then obtained. The emulsion obtained is then diluted in water so as to obtain a suitable volume fraction in dispersed phase.

Finally, the emulsion may be prepared by using colloidal mills such as Manton Gaulin and Microfluidizer mills (Microfluidics).

The mean size of the droplets of the liquid composition dispersed in the aqueous phase is generally between 0.1 μm and 50 μm, often between 1 and 10 micrometers and preferentially between 0.2 and 5 micrometers (expressed relative to the volume of particles; measured using a Horiba laser-scattering granulometer).

The emulsification may be performed at a temperature in the region of room temperature, although lower or higher temperatures may be envisioned.

The amount of water present in the emulsion, before drying, may be between 5% and 99% by weight and preferably between 20% and 70% by weight. In general, small amounts of water are preferably used, since it must be removed thereafter.

The method used for removing the water from the emulsion and obtaining the dried emulsion may be performed by any means known to those skilled in the art.

This operation takes place such that the various constituent components of the mixture are subjected to temperatures below their degradation temperature.

According to one embodiment of the invention, oven drying may be envisioned. Preferably, this drying takes place in a thin layer. More particularly, the temperature at which the drying is performed is less than or equal to 100° C., preferably between 30° C. and 90° C. and preferably between 50° C. and 90° C.

According to another particular embodiment of the invention, rapid drying of the mixture (or of the emulsion) is performed. Spray-drying, in a fluidized bed, using Duprat® drums, or freeze-drying (freezing-sublimation) is suitable in this respect.

Spray-drying, for example using a Niro machine, or in a fluidized bed, for example using an Aeromatic machine, may usually be performed in any known machine, for instance a spraying tower combining spraying performed with a nozzle or a turbine with a stream of hot gas. The inlet temperature of the hot gas (generally air), at the top of the column, is preferably between 50° C. and 250° C. and the outlet temperature is preferably less than the degradation temperature of the constituent components of the granule obtained.

In the case of operations for drying the mixture (or the emulsion) performed using a Duprat® drum, or any means for rapidly obtaining a dry film that is separated from the drying support by scraping, for example, particles that may optionally be ground are obtained. If necessary, these particles may be subjected to subsequent shaping, for instance an agglomeration step, so as to obtain granules.

It should be noted that additives, such as anticaking agents, may be incorporated into the granules during this drying step.

Preferably, the drying is performed such that at least 90% by weight and preferably between 90% and 95% by weight of the outer aqueous phase is removed. The residual amount of water is preferably less than 3% by weight.

According to one embodiment of the invention, the solid formulation is a wettable powder (WP). A process suitable for preparing such a formulation comprises the following steps:
mixing the components in a blender (ribbon blender). Premixes are optionally used for impregnation of the liquid components,
dry-grinding or dry-micronization of the mixture to obtain the desired size (hammer mill or air jet mill).

According to one embodiment of the invention, the solid formulation is a water-dispersible solid granule (WDG). A process suitable for preparing such a formulation comprises the following steps:
impregnating the mineral or organic support with the liquid composition, said support preferably being in the form of a powder,
agglomerating the impregnated support, preferably in the presence of a binder and/or dispersant, so as to obtain granules.

Agglomeration processes are known to those skilled in the art. They may be chosen, for example, from atomization processes, extrusion processes (at relatively low pressure, below 30 psi, or at higher pressure, above 30 psi), fluid-bed granulation processes, high-speed-mixing granulation processes, pan granulation processes and compacting processes.

It is pointed out that the agglomeration processes may be performed in the presence of water, which is removed thereafter (typically to a level of less than 2% by weight), for example by drying. The binder and/or dispersant may be mixed with this water beforehand. The amount of water used for the agglomeration may depend on the process used and on the desired formulation. It may typically be from 5 to 150 parts by weight per 100 parts of mineral or organic support and of binder and/or dispersant.

In the context of an agglomeration by atomization, the process may be performed, for example, in the following manner:
preparation of a suspension comprising the liquid composition absorbed or adsorbed onto the mineral or organic support, water, a binder and/or dispersant, and optionally other ingredients,
atomization using a suitable device,
drying so as to remove the water.

In the context of agglomeration by fluid-bed granulation, the process may be performed, for example, in the following manner:
transportation in a fluid bed of the mineral or organic support comprising the absorbed or adsorbed liquid composition,
spraying of a composition comprising water and a binder and/or dispersant onto the fluid bed, so as to agglomerate the support,
drying using a flow of hot air, so as to obtain granules.

It is mentioned that the process chosen, the operating conditions and the solvent are such that solvent remains in the solid formulation, preferably in the amounts indicated above.

### Preparation of the Liquid Composition:

The liquid composition, comprising the phytosanitary product, the solvent, the amphiphilic compounds, and optionally other ingredients (for example a dispersant), may be prepared via any process for placing these compounds in contact. According to one advantageous embodiment, a premix comprising the solvent, and the amphiphilic compound, and optionally other ingredients (for example a dispersant) is first prepared. The phytosanitary product is then dissolved in this premix, to obtain the liquid composition.

### Dispersion in Water—Dispersion of Nanoparticles

The solid formulation is intended to be mixed with water, to form a dispersion of nanoparticles. The mixing with water is such that proportions indicated for phytosanitary treatments are achieved, with a formation of nanoparticles. The mixing operation is generally performed by the final operator, generally an agricultural worker. Advantageously, at least 10 parts by weight of water per 1 part by weight of solid formulation, preferably at least 50 parts by weight of water and even more preferably at least 100 parts by weight of water, and occasionally at least 250 parts by weight of water or even at least 500 parts by weight of water, are mixed.

Other details or advantages of the invention may become apparent in the light of the nonlimiting example which follows.

### EXAMPLE

### a) Preparation of an Emulsion

29.2 grams of Geropon EGPM (Rhodia), which is an aqueous solution comprising a water-soluble polymer, are introduced into a high-sided 250 ml glass beaker, and are stirred using a deflocculating paddle (D=35 mm) at a speed of 800 revolutions/minute (rpm).
4 grams of Glucidex DE29 (maltodextrin sold by Roquette) are added slowly and the mixture is stirred for 30 to 60 minutes at 800 revolutions/minute.
The system prepared beforehand consisting of 1.86 grams of tebuconazole dissolved in 6.4 grams of Genagene 4166 (Clariant), to which are added 2.45 grams of Rhodafac MB (alcohol phosphate anionic surfactant sold by Rhodia) is added slowly.
A white emulsion that thickens slowly is thus obtained.
2.59 grams of hydrochloric acid (2N HCl) are added dropwise.
Thickening of the emulsion is observed.
The mixture is stirred for 1 hour 15 minutes at 1000 revolutions/minute, having taken the precaution to place the beaker in a bath of cold water (10° C.).
The particle size is measured (Horiba).

### b) Drying

The emulsion obtained is spread into a thin layer on a plate and oven-dried at 80° C. for three hours forty minutes.
The dried emulsion is recovered and ground coarsely.

### c) Redispersion, Characterization

The particle size is measured during redispersion (1 g of powder in 50 ml of tap water, with an electromagnetic stirrer, at 500 revolutions/minute, for 5 minutes at room temperature using a Horiba granulometer).
The hydrodynamic radius of the particles obtained is also measured by light scattering using a Malvern ALV CGS-3 machine (the concentrations used are 2.5 g/l). The measurements are taken at angles of 90° and 135°. The self-correlation function allows two values to be obtained: the mean hydrodynamic diameter weighted by the scattered intensity, and a polydispersity index (dimensionless), which is close to zero for a monodisperse sample.
Finally, the particles obtained are characterized by transmission electron microscopy after depositing the dispersion on a grate and leaving it to dry.

The formulation is indicated in the table below, in which the commercial names of the products used, their solids contents, the masses introduced and finally the corresponding dry equivalent (mass and percentage) are given.

| | | |
|---|---|---|
| S.C. | Mass | Dry |

| | % | g | g | % |
|---|---|---|---|---|
| Geropon EGPM | 25.0% | 29.20 | 7.30 | 32.88% |
| Glucidex DE19 | 100.0% | 4.00 | 4.00 | 18.02% |
| 2 N HCl (73 g/l) | 7.3% | 2.59 | 0.19 | 0.85% |
| Rhodafac MB | 100.0% | 2.45 | 2.45 | 11.04% |
| Tebuconazole | 100.0% | 1.86 | 1.86 | 8.38% |
| Genagene 4166 | 100.0% | 6.40 | 6.40 | 28.83% |
| Water (supplement for | 0.0% | 0.00 | 0.00 | 0.00% |
| final viscosity) | | | | |
| | Total = | 46.5 | 22.2 | 100% |

### Emulsion Before Drying

Solids content: 47.7%

Particle size before drying (Horiba): bipopulated

| Fine fraction: | Coarse fraction: |
|---|---|
| D10 = 0.59 μm | D10 = 5.8 μm |
| D50 = 1.16 μm | D50 = 13.2 μm |
| D90 = 2.36 μm | D90 = 23.0 μm |
| (D90 − D10)/D50 = 1.52 | (D90 − D10)/D50 = 1.3 |

### Dispersion After Drying

### Horiba Particle Size

### D10=216 nm

### D50=322 nm

### D90=543 nm

### (D90-D10)/D50=0.74

### Light Scattering

| angle 90° | <Φₕ>_{int.diff.} | angle 135° | <Φₕ>_{int.diff.} |
|---|---|---|---|
| 2.5 g/l | 323.0 | 2.5 g/l | 290.0 |
| | Polydispersity | | Polydispersity |
| angle 90° | index | angle 135° | index |
| 2.5 g/l | 0.23 | 2.5 g/l | 0.29 |

The mean diameters obtained at 135° are smaller than at 90° on account of the polydispersity: the coarsest populations contribute more to the signal at 90° than at 135°. The diameter range in which a volume-weighted distribution is expected is between 150 nm and 350 nm, in accordance with the particle size measurements.

### Transmission Electron Microscopy

Electron microscopy reveals particles agglomerated under the effect of drying for this characterization, the particles once again having a size similar to those measured previously.

1-14. (canceled)

15. A solid formulation comprising a liquid composition comprising a water-insoluble solid phytosanitary product dispersed in or absorbed or adsorbed onto an organic or mineral matrix, wherein:
the phytosanitary product is water-insoluble at 25° C.,
the liquid composition comprises:
at least 5 parts by weight and optionally at least 50 parts by weight of the phytosanitary product,
a solvent in which the phytosanitary product is dissolved, and
100 parts by weight of at least one amphiphilic compound,
the solvent, the amphiphilic compound and the proportions thereof being such that their mixture under the conditions of use, optionally in the presence of the organic matrix or of a binder and/or dispersant included in the mineral or organic matrix, is at least partially water-miscible,
and wherein the solid formulation forms, after mixing with water, a dispersion in the water of nanoparticles comprising the phytosanitary product.

16. The formulation as claimed in claim 15, wherein the nanoparticles have a weight or volume median size of less than 1060 nm, optionally greater than 100 nm.

17. The formulation as claimed in claim 15, wherein at least 75% by weight or volume of the nanoparticles are smaller than 1060 mn and optionally smaller than 400 nm.

18. The formulation as claimed in claim 15, being a dried emulsion (EG) comprising an organic matrix in which are dispersed inclusions of the liquid composition.

19. The formulation as claimed in claim 15, wherein the organic matrix is a water-soluble or water-dispersible polymer which is polyvinyl alcohol, optionally modified starches, or copolymers of (meth)acrylic acid or of maleic anhydride and of diisobutylene.

20. The solid formulation as claimed in claim 15, being:
a wettable powder (WP) comprising a matrix mineral or organic support onto which the liquid composition is absorbed or adsorbed, and comprising an agent for promoting the dispersion of the mineral or organic support in water, or
a water-dispersible solid granule (WDG), comprising an agglomerate or a matrix mineral or organic support onto which the liquid composition is absorbed or adsorbed, and optionally comprising a binder and/or an agent for promoting the dispersion in the water of the mineral or organic support.

21. The formulation as claimed in claim 20, wherein the support is a matrix mineral support which is:
silica, optionally a precipitation silica,
mineral compounds comprising phosphorus,
silicates or metasilicates of alkali metal or alkaline-earth metal compounds,
carbonates of alkali metal or alkaline-earth metal compounds, carbon black, or clays.

22. The formulation as claimed in claim 20, wherein the support is a precipitation silica with a DOP oil uptake of at least 200 ml/g.

23. The formulation as claimed in claim 20, further comprising a binder and/or agent for promoting dispersion, said agent being:
water-soluble polymers, optionally polycarboxylates, and derivatives and/or copolymers thereof,
naphthalenesulfonate condensates,
condensed naphthalenesulfonate/formaldehyde polymers (sodium or ammonium salts),
phenylsulfonate condensates (sodium salts of phenylsulfonic acids),
crosslinked polyvinylpyrrolidones,
polysaccharides and derivatives thereof,
copolymers, optionally block copolymers, of ethylene oxide and of propylene oxide,
sulfoesters, or
lignosulfonates.

24. The formulation as claimed in claim 20, further comprisisng at least one water-soluble salt.

25. The formulation as claimed in claim 15, wherein the amphiphilic compound is:
surfactants comprising a hydrophilic group and a hydrophobic group, or
block copolymers, optionally diblock or triblock copolymers, comprising at least one hydrophilic block and at least one hydrophobic block, optionally block copolymers in which at least one block, optionally at least two blocks, are derived from ethylenically unsaturated monomers.

26. The formulation as claimed in claim 25, wherein the surfactant is anionic surfactants, in salified or neutral form, or nonionic surfactants, which are optionally polyalkoxylated.

27. A process for preparing a dispersion of nanoparticles comprising a phytosanitary product, comprising the step of mixing the solid formulation as defined in claim 15 with water.

28. The process as claimed claim 27, wherein the mixture is of at least 100 parts by weight of water per 1 part of solid formulation.
